(19) United States
(12) Patent Application Publication
(10) Pub. No.: US 2016/0268873 A1
(43) Pub. Date: Sep. 15, 2016

(54) POWER TOOL

(71) Applicant: Panasonic Intellectual Property Management Co., Ltd., Osaka (JP)

(72) Inventors: Masaki IKEDA, Mie (JP); Naoki TSURUTA, Mie (JP)

(21) Appl. No.: 15/058,577

(22) Filed: Mar. 2, 2016

(30) Foreign Application Priority Data
Mar. 12, 2015 (JP) 2015-049650

(51) Int. Cl. H02K 7/14; H02K 11/00

(52) U.S. Cl. CPC H02K 7/145; H02K 11/0094

(57) ABSTRACT

A power tool includes a motor that is driven by power supplied from a battery pack, a trigger switch that is operable by a user, and a controller that controls the motor in accordance with an operation amount of the trigger switch, wherein the controller includes a load determination unit that uses a terminal voltage of the battery pack when the motor is stopped as a reference voltage to determine load applied to the motor based on a relationship of a voltage drop amount from the reference voltage when the motor is driven, the operation amount of the trigger switch, and an operation time of the trigger switch.

### CROSS-REFERENCE TO RELATED APPLICATIONS

This application is based upon and claims the benefit of priority from prior Japanese Patent Application No. 2015-049650, filed on Mar. 12, 2015, the entire contents of which are incorporated herein by reference.

### FIELD

The present invention relates to a power tool.

### BACKGROUND

Japanese Laid-Open Patent Publication No. 2014-213422 discloses a handheld power tool. The handheld power tool includes a battery pack attached in a removable manner to a power tool body that includes, for example, a motor and a control circuit. The battery pack, which has a built-in rechargeable battery that includes battery cells, supplies drive power to the power tool body.

The motor of the above power tool has a high output. This increases the load applied to the motor and the motor easily heats. When the load applied to the motor increases, the power tool may fail to function. Thus, to protect the motor from an overload, the state of the motor may be monitored using, for example, a temperature sensor that detects the temperature of the motor, a rotation sensor that detects the rotation speed of the motor, or a current detector that detects current flowing through the motor. However, it is difficult to increase the number of sensors and provide room for sensors. Accordingly, it is desirable that a power tool that allows for determination of the load applied to the motor with a limited number of components be developed.

### SUMMARY

A power tool according to one aspect of the present invention includes a motor that is driven by power supplied from a battery pack, a trigger switch that is operable by a user, and a controller that controls the motor in accordance with an operation amount of the trigger switch, wherein the controller includes a load determination unit that uses a terminal voltage of the battery pack when the motor is stopped as a reference voltage to determine load applied to the motor based on a relationship of a voltage drop amount from the reference voltage when the motor is driven, the operation amount of the trigger switch, and an operation time of the trigger switch.

### BRIEF DESCRIPTION OF THE DRAWINGS

FIG. 1 is a schematic side view showing the structure of one embodiment of a power tool.

FIG. 2 is a schematic block diagram showing the configuration of the power tool.

FIG. 3 is a graph showing the relationship of a trigger operation amount of a trigger switch and a duty ratio of a controller in the power tool.

FIG. 4 is a graph showing the estimated current based on the operation amount of the trigger switch and a voltage drop amount of a battery pack in the power tool.

FIG. 5 is a graph showing the temperature increase in a motor that is caused by the difference in the amount of current flowing in the motor of the power tool.

FIG. 6 is a graph showing the voltage drop amount in one operation example of the power tool.

FIG. 7 is a diagram showing one operation example of the power tool.

FIG. 8 is a diagram showing one operation example of the power tool.

### DESCRIPTION OF EMBODIMENTS

One embodiment of a power tool will now be described with reference to the drawings.

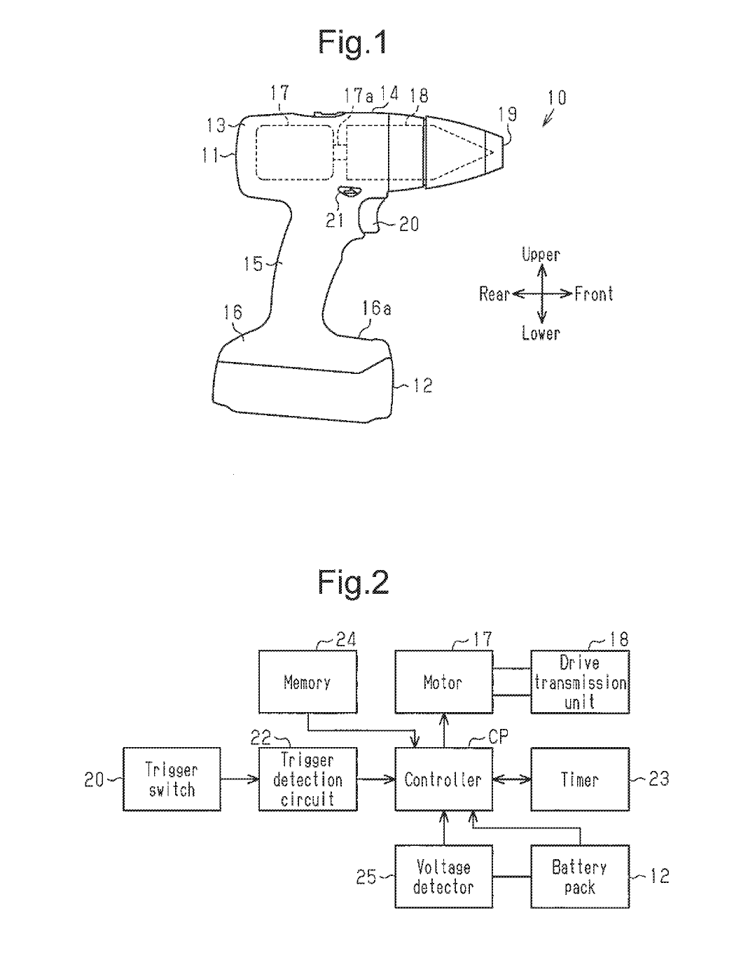

As shown in FIG. 1, a power tool 10 of the present embodiment includes a power tool body 11 and a battery pack 12, which is attached to the power tool body 11 in a removable manner.

A housing 13, which forms the shell of the power tool body 11, includes a tubular body 14, a grip 15, and a battery pack seat 16. The grip 15 extends downward from the middle of the body 14 in the longitudinal direction. The battery pack seat 16 receives the battery pack 12 at the lower end of the grip 15.

As shown in FIG. 1, the body 14 includes a motor 17 and a drive transmission unit 18, which are arranged in the body 14. The drive transmission unit 18 is coupled to a motor shaft 17a of the motor 17. The drive transmission unit 18 transmits rotational drive force generated by the motor 17 to an output shaft (not shown), which is located in front of the drive transmission unit 18. The drive transmission unit 18 includes, for example, a reduction drive and a clutch mechanism.

The drive transmission unit 18 is coupled to a chuck 19 located at a distal end of the output shaft. Thus, the drive transmission unit 18 rotates the chuck 19 when the motor 17 produces rotation. A bit such as a screwdriver bit or a tap is attached to the chuck 19 in a removable manner and rotated together with the chuck 19. In the present embodiment, the axial direction of the motor shaft 17a of the motor 17 is referred to as the longitudinal (front-to-rear) direction, the direction in which the grip 15 extends is referred to as the vertical direction, and the widthwise direction of the power tool 10 orthogonal to the front-to-rear direction and the vertical direction is referred to as the lateral direction.

The grip 15 of the power tool body 11 extends downward from the longitudinally middle portion of the body 14. A trigger switch 20 is arranged at the upper end of the grip 15. A user operates the trigger switch 20 to instruct the power tool body 11 to start and stop operating. The location of the grip 15 is not particularly limited as long as the grip 15 is arranged on the power tool body 11.

A forward-reverse switch 21 is arranged slightly above the trigger switch 20. For example, the forward-reverse switch 21 is exposed and projected from the surface of the grip 15. The location of the forward-reverse switch 21 is not particularly limited as long as the forward-reverse switch 21 is arranged on the power tool body 11. The user uses the forward-reverse switch 21 to instruct the rotation direction of a tool (bit), that is, the rotation direction of the motor 17. The forward-reverse switch 21 includes an operation lever that extends through the grip 15 in the lateral direction. The operation lever is moved in the lateral direction to instruct the rotation direction of the motor 17.

The battery pack seat 16 is arranged at the lower end of the grip 15. The battery pack seat 16 has the form of a flat box elongated in the longitudinal direction (front-to-rear direction) of the body 14.

The electrical configuration of the power tool 10 of the present embodiment will now be described with reference to FIG. 2.

As shown in FIG. 2, the power tool 10 includes the motor 17, a controller CP, the trigger switch 20, a trigger detection circuit 22, a timer 23, a memory 24, the battery pack 12, and a voltage detector 25.

The trigger detection circuit 22 is electrically connected to the controller CP. The trigger detection circuit 22 provides the controller CP with an operation signal that drives the motor 17 in accordance with the operated amount (pulled amount) of the trigger switch. Such a trigger detection circuit 22 is also included in a conventional power tool in the same manner.

The timer 23 is electrically connected to the controller CP. The timer 23 measures the operation time of the trigger switch 20. The timer 23 includes, for example, a counter circuit.

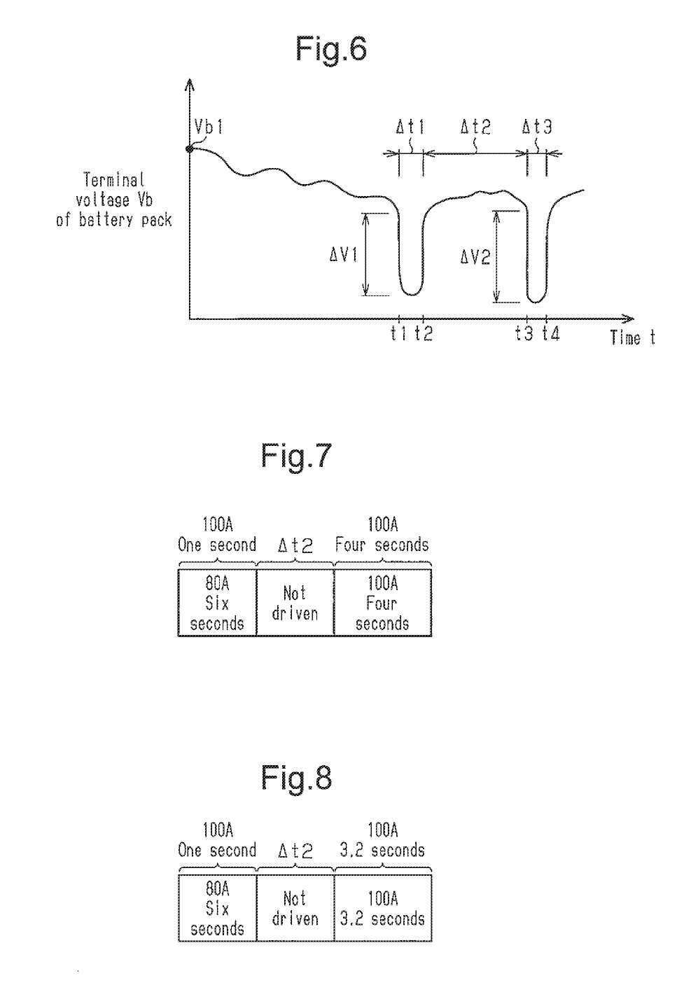

The memory 24 stores various types of information. For example, the memory 24 stores a terminal voltage Vb of the battery pack 12 immediately before operation of the trigger switch 20, that is, before the motor 17 is driven, as a reference voltage Vb1 (refer to FIG. 6).

The voltage detector 25 is configured to detect the terminal voltage Vb of the battery pack 12 and provide the controller CP with information related to the detected terminal voltage Vb.

The controller CP is configured to supply power from the battery pack 12 to the motor 17 based on an operation signal from the trigger detection circuit 22.

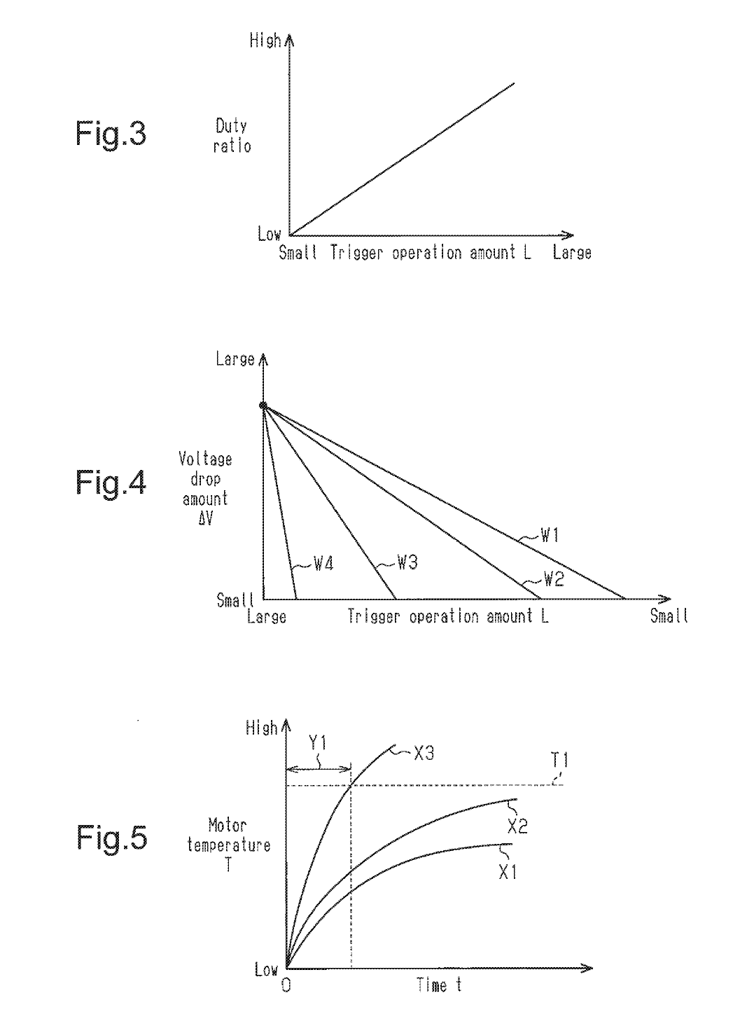

More specifically, as shown in FIGS. 2 and 3, the controller CP controls the motor 17 to perform PWM control on switching elements (not shown) at a higher duty ratio as the trigger operation amount L increases.

Further, when provided with the operation signal from the trigger detection circuit 22, the controller CP activates the timer 23 to measure the operation time of the trigger switch 20.

FIG. 4 shows the relationship of the trigger operation amount L and a voltage drop amount ΔV.

As shown by straight lines W1 to W4 in FIG. 4, the trigger operation amount L increases as the voltage drop amount ΔV increases. Straight lines W1 to W4 in FIG. 4 each show the required torque that differs depending on the task. More specifically, the required torque increases in the order of straight lines W1, W2, W3, and W4. The T-I characteristic of the motor also increases the required current value in this order. For example, straight line W1 indicates a task operation performed when the current value is 5 A, straight line W2 indicates a task performed when the current value is 20 A, straight line W3 indicates a task performed when the current value is 40 A, and straight line W4 indicates a task performed when the current value is 100 A.

In the power tool 10 of the present embodiment, the above relationship is stored in the memory 24 in advance as a table for estimating current. This allows the controller CP to estimate the value of the current that flows through the motor 17 with reference to the current estimation table, which is stored in the memory 24, using the voltage drop amount ΔV, which is detected by the voltage detector 25 when the motor 17 is driven, and the trigger operation amount L, which is detected by the trigger detection circuit 22.

FIG. 5 is a graph showing the temperature increase of the motor that is caused by differences in value of current flowing through the motor.

As shown by lines X1 to X3 in FIG. 5, the temperature of the motor gradually increases when the motor is driven. In FIG. 5, lines X1 to X3 represent different values of current that flow through the motor. More specifically, the value of the current flowing through the motor increases in the order of lines X1, X2, and X3, in which line X1 represents 10 A, line X2 represents 50 A, and line X3 represents 100 A.

As described above, the controller CP is capable of estimating the temperature of the motor 17 from, for example, the current value estimated by the controller CP (estimated current value). This allows the controller CP to determine the load applied to the motor 17. Thus, the controller CP functions includes a load determination unit. An example of a motor load determination will now be described. With reference to FIG. 5, in the motor load determination described below, overload is determined at temperature T1 that corresponds to operable time Y1 (for example, four seconds) of the motor in line X3, which indicates that the current value is 100 A.

Motor Load Determination Function

As shown in FIG. 2, the controller CP uses the voltage detector 25 to measure (obtain) the terminal voltage Vb (reference voltage Vb1 (refer to FIG. 6)) of the battery pack 12 immediately before a task is started. Then, the controller CP stores the terminal voltage Vb in the memory 24.

When the trigger switch 20 is operated, the trigger detection circuit 22 provides the controller CP with an operation signal. When receiving the operation signal, the controller CP supplies power to the motor 17 to drive the motor 17. The controller CP activates the timer 23 to start measuring the task time.

Further, the controller CP uses the voltage detector 25 to detect the terminal voltage Vb of the battery pack 12 constantly or at predetermined timings.

Referring to FIG. 6, when a voltage drop amount ΔV1 that is larger than a predetermined value occurs at time t1, the controller CP (FIG. 2) refers to the table in the memory 24 (FIG. 2) to estimate the current value of the motor 17 (FIG. 2) from the voltage drop amount ΔV1.

Referring to FIG. 2, the controller CP uses the timer 23 to obtain the period during which current continues to flow at the estimated value. In this example, during period Δt1 (time t1 to time t2), the controller CP estimates that the current value of the motor 17 is 80 A from the voltage drop amount ΔV1 and determines that the current value of the motor 17 has been continuously 80 A for six seconds, which is measured by the timer 23. Referring to FIG. 7, a task in which 80 A of current flows through the motor 17 for six seconds is equivalent to a task in which 100 A of current flows through the motor 17 for about one second. When the controller CP determines that the task in which 100 A of current of flows through the motor 17 for about one second is not an overload, the controller CP temporarily stores the task content of period Δt1 (80 A, six seconds) in the memory 24. That is, the controller CP compares the period in which 100 A of current flows through the motor 17 with operable time Y1 and determines that the period is shorter than operable time Y1 of the motor. Thus, the controller CP determines that this task does not result in an overload.

When period Δt2 (time t2 to time t3), which follows period Δt1, is greater than or equal to a predetermined time (for example, three seconds), the controller CP determines that the motor, which was heated during period Δt1, has been sufficiently cooled and deletes the task content from the memory 24. That is, when a predetermined time elapses from when the voltage drop ends during period Δt1, the controller CP determines that the heated motor has been sufficiently cooled and deletes the operation amount from the memory 24.

Referring to FIG. 6, when a voltage drop amount ΔV2, which is greater than a predetermined value, occurs at time t3, the controller CP refers to the table in the memory 24 (FIG. 2) to estimate the current value of the motor 17 (FIG. 2) from the voltage drop amount ΔV2.

The controller CP uses the timer 23 to measure the period during which current continues to flow at the estimated value. In this example, referring to FIG. 7, when a voltage drop amount ΔV2 occurs during period Δt3 (time t3 to time t4), the controller CP estimates that the current value of the motor 17 is 100 A and determines that the current value of the motor 17 has been 100 A for four seconds, which is measured by the timer 23. The controller CP compares the period during which 100 A of current flows through the motor with operable time Y1 and determines that the period is the same as operable time Y1 of the motor. Thus, the controller CP determines that the task in which 100 A of current flows through the motor 17 for four seconds results in an overload and stops the motor 17.

When period Δt2, which follows period Δt1, is shorter than the predetermined time (for example, three seconds), the controller CP stores the task content of period Δt1 in the memory.

When the voltage drop amount ΔV2, which is greater than the predetermined value, occurs at time t3 as shown in FIG. 6, the controller CP (FIG. 2) refers to the table in the memory 24 (FIG. 2) to estimate the value of the current flowing through the motor 17 from the voltage drop amount ΔV2. The controller CP uses the timer 23 to measure the period during which current continues to flow at the estimated value. In this example, referring to FIG. 8, the controller CP estimates that the current value of the motor 17 is 100 A from the voltage drop amount ΔV2 and determines that the current value of the motor 17 has been 100 A for 3.2 seconds, which is measured by the timer 23. Referring to FIG. 8, the estimated current value of period Δt3, during which the voltage drop amount ΔV2 occurs, is equivalent to a task in which 100 A of current flows through the motor 17 for 3.2 seconds. The controller CP adds the task in which 100 A of current flows through the motor 17 for approximately one second during period Δt1 and the task in which 100 A of current flows through the motor 17 for 3.2 seconds during period Δt3 to make a determination for a task in which 100 A of current flows through the motor 17 for four seconds. The controller CP compares the period of four seconds, during which 100 A of current flows through the motor 17, with operable time Y1 (for example, four seconds). If the period is longer than or equal to operable time Y1 of the motor, the controller CP determines the task results in an overload and stops the motor 17.

The present embodiment has the advantages described below.

(1) The controller CP determines the load applied to the motor 17 with the relationship of the voltage drop amount ΔV from the reference voltage Vb1 when the motor 17 is driven, the operation amount of the trigger switch 20, and the operation time of the trigger switch 20. In this manner, the controller CP determines the load applied to the motor 17 using the operation amount of the trigger switch 20 and the terminal voltage (voltage drop amount) of the battery pack 12. The trigger switch 20 and the battery pack 12 are also included in a conventional power tool. In other words, there is no need for sensors that monitor, for example, the rotation speed, temperature, and current of the motor 17. This allows the controller CP to determine the load applied to the motor 17 while limiting the number of components.

(2) The controller CP estimates the current that flows through the motor 17 with the voltage drop amount ΔV from the reference voltage Vb1. If the operation time of the motor 17 at the estimated current exceeds operable time Y1, the controller CP determines that an overload is applied to the motor 17 and stops the motor 17. In this manner, when it is determined that an overload is applied to the motor 17, the motor 17 is stopped. This reduces overloads applied to the motor 17 and limits failures of the motor 17 caused by heat.

It should be apparent to those skilled in the art that the present invention may be embodied in many other specific forms without departing from the spirit or scope of the invention. Particularly, it should be understood that the present invention may be embodied in the following form.

In the embodiment, operable time Y1 is four seconds when a task is performed at 100 A. However, operable time Y1 may be changed in accordance with the specifications of the power tool and the motor.

The present disclosure includes the embodiments described below.

### Embodiment 1

A power tool (10) includes a motor (17) that is driven by power supplied from a battery pack, a trigger switch (20) that is operable by a user, and a controller (CP) that controls the motor (17) in accordance with an operation amount of the trigger switch (20). The controller (CP) includes a load determination unit (CP) that uses a terminal voltage of the battery pack when the motor (17) is stopped as a reference voltage to determine load applied to the motor (17) based on a relationship of a voltage drop amount from the reference voltage when the motor (17) is driven, the operation amount of the trigger switch (20), and an operation time of the trigger switch (20).

### Embodiment 2

The load determination unit (CP) estimates current that flows through the motor (17) in accordance with the voltage drop amount from the reference voltage when the motor (17) is driven and determines that overload is applied to the motor (17) when the motor (17) operates for a predetermined operable time or longer at the estimated current, and the controller stops the motor (17) when the load determination unit (CP) determines that an overload is being applied to the motor (17).

### Embodiment 3

The power tool (10) further includes a memory that stores a table indicating a relationship of the voltage drop amount from the reference voltage when the motor (17) is driven and the operation amount of the trigger switch (20). The load determination unit (CP) is configured to specify the voltage drop amount from the reference voltage when the motor (17) is driven from the operation amount of the trigger switch (20) based on the table.

### Embodiment 4

The table indicates the relationship of the voltage drop amount and the operation amount of the trigger switch (20) for each of a plurality of tasks in which the motor (17) operates with different torques.

### Embodiment 5

The load determination unit (CP) is configured to specify the voltage drop amount from the operation amount of the trigger switch (20) based on the relationship of the voltage drop amount and the operation amount of the trigger switch (20) that corresponds to one of the tasks in the table.

### Embodiment 6

The power tool (10) further includes a timer that measures the operation time of the trigger switch (20) to generate first operation time data that shows the measured operation time.

### Embodiment 7

The load determination unit (CP) is configured to receive the first operation time data from the timer, specify a first period during which the estimated current flows through the motor (17) based on the first operation time data, compare a first period of the motor (17) with the predetermined operable time, and determine that overload is applied to the motor (17) when determining that the first period is longer than or equal to the predetermined operable time.

### Embodiment 8

When the trigger switch (20) is operated again, the timer measures the operation time of the trigger switch (20) to generate second operation time data that shows the measured operation time. The load determination unit (CP) is configured to receive the second operation time data from the timer, specify a second period during which the estimated current flows through the motor (17) based on the second operation time data, and add the first period to the second period to compare the added period with the predetermined operable time.

### Embodiment 9

When the trigger switch (20) is operated again after a predetermined time elapses from when the trigger switch (20) was previously operated, the load determination unit (CP) is configured to compare only the second period with the predetermined operable time.

### Embodiment 10

The load determination unit (CP) is configured to measure a terminal voltage of the battery pack constantly or at predetermined timings to store the measured terminal voltages of the battery pack in the memory, and select the one of the terminal voltages of the battery pack stored in the memory that was measured immediately before operation of the trigger switch (20) as the reference voltage.

The present examples and embodiments are to be considered as illustrative and not restrictive, and the invention is not to be limited to the details given herein, but may be modified within the scope and equivalence of the appended claims.

1. A power tool comprising:
a motor that is driven by power supplied from a battery pack;
a trigger switch that is operable by a user; and
a controller that controls the motor in accordance with an operation amount of the trigger switch;
wherein the controller includes a load determination unit that uses a terminal voltage of the battery pack when the motor is stopped as a reference voltage to determine load applied to the motor based on a relationship of a voltage drop amount from the reference voltage when the motor is driven, the operation amount of the trigger switch, and an operation time of the trigger switch.

2. The power tool according to claim 1, wherein
the load determination unit estimates current that flows through the motor in accordance with the voltage drop amount from the reference voltage when the motor is driven and determines that overload is applied to the motor when the motor operates for a predetermined operable time or longer at the estimated current, and
the controller stops the motor when the load determination unit determines that an overload is being applied to the motor.

3. The power tool according to claim 2, further comprising a memory that stores a table indicating a relationship of the voltage drop amount from the reference voltage when the motor is driven and the operation amount of the trigger switch, wherein
the load determination unit is configured to specify the voltage drop amount from the reference voltage when the motor is driven from the operation amount of the trigger switch based on the table.

4. The power tool according to claim 3, wherein the table indicates the relationship of the voltage drop amount and the operation amount of the trigger switch for each of a plurality of tasks in which the motor operates with different torques.

5. The power tool according to claim 4, wherein the load determination unit is configured to specify the voltage drop amount from the operation amount of the trigger switch based on the relationship of the voltage drop amount and the operation amount of the trigger switch that corresponds to one of the tasks in the table.

6. The power tool according to claim 2, further comprising a timer that measures the operation time of the trigger switch to generate first operation time data that shows the measured operation time.

7. The power tool according to claim 6, wherein the load determination unit is configured to:
receive the first operation time data from the timer;
specify a first period during which the estimated current flows through the motor based on the first operation time data;
compare a first period of the motor with the predetermined operable time; and
determine that overload is applied to the motor when determining that the first period is longer than or equal to the predetermined operable time.

8. The power tool according to claim 7, wherein when the trigger switch is operated again, the timer measures the operation time of the trigger switch to generate second operation time data that shows the measured operation time, and
the load determination unit is configured to:
receive the second operation time data from the timer;
specify a second period during which the estimated current flows through the motor based on the second operation time data; and
add the first period to the second period to compare the added period with the predetermined operable time.

9. The power tool according to claim 8, wherein when the trigger switch is operated again after a predetermined time elapses from when the trigger switch was previously operated, the load determination unit is configured to compare only the second period with the predetermined operable time.

10. The power tool according to claim 3, wherein the load determination unit is configured to:
measure a terminal voltage of the battery pack constantly or at predetermined timings to store the measured terminal voltages of the battery pack in the memory; and
select the one of the terminal voltages of the battery pack stored in the memory that was measured immediately before operation of the trigger switch as the reference voltage.
